(19) United States
(12) Patent Application Publication
(10) Pub. No.: US 2026/0141305 A1
(43) Pub. Date: May 21, 2026

(54) Method for training a model for generating at least one control signal for at least one functional device of a motor vehicle, a computer program product as well as an electronic computing device

(71) Applicant: Mercedes-Benz Group AG, Stuttgart (DE)

(72) Inventors: Farris Atif, Alamo, CA (US); Cosmin Dragoiu, San Jose, CA (US); Faezeh Tafazzoli, San Jose, CA (US)

(21) Appl. No.: 19/389,617

(22) Filed: Nov. 14, 2025

(30) Foreign Application Priority Data
Nov. 15, 2024 (GB) 2416814.8

(51) Int. Cl. G06N 20/00; B60W 50/08

(52) U.S. Cl. CPC G06N 20/00; B60W 50/082

(57) ABSTRACT

A method for training includes training a model for generating at least one control signal for at least one functional device of a motor vehicle by an electronic computing device of the motor vehicle, including the steps of: receiving a general trained model from a cloud server by the electronic computing device; providing personalized data from a user of the motor vehicle by the electronic computing device; generating training data for the general trained model depending on the personalized data by the electronic computing device; further training of the general trained model with the generated training data by the electronic computing; and providing the further trained model as a personalized model for generating the at least one control signal for the at least one functional device by the electronic computing device. Furthermore, the present method includes a computer program product, as well as an electronic computing device.

### CROSS-REFERENCE TO RELATED APPLICATIONS

The present application is based upon and claims the right of priority to GB Patent Application No. 2416814.8, filed on Nov. 15, 2024, the disclosure of which is hereby incorporated by reference herein in its entirety for all purposes.

### FIELD OF THE INVENTION

The present disclosure relates to the field of automobiles. More specifically, the present disclosure relates to a method for training a model for generating at least one control signal for at least one functional device of a motor vehicle by an electronic computing device of the motor vehicle. Furthermore, the present disclosure relates to a corresponding computer program product, as well as to an electronic computing device.

### BACKGROUND INFORMATION

The so-called federated learning is a popular approach to train models on personalized data. In this setup, individual models are trained on devices, and model updates are sent to the cloud for a model averaging. Therefore, the model training on the cloud server needs data in order to be trained.

On the other side, personalized data needs to be anonymized in order to comply with the data security of private data.

Therefore, there is a need in the art to provide personalized models for the usage in a motor vehicle and on the other side to comply with the data security of private data.

### SUMMARY OF THE INVENTION

Disclosed herein is a method, a corresponding computer program product, as well as a corresponding electronic computing device, by which a personalized model can be provided for a motor vehicle in an improved manner.

Disclosed herein is a method, a corresponding computer program product, as well as a corresponding electronic computing device according to the independent claims. Advantageous embodiments are presented on the dependent claims.

One aspect of the method for training includes a model for generating at least one control signal for at least one functional device of a motor vehicle by an electronic computing device of the motor vehicle. A general trained model is received from a cloud server by the electronic computing device. Personalized data from a user of the motor vehicle is provided by the electronic computing device. Training data for the general trained model is generated depending on the personalized data by the electronic computing device. Further training of the general trained model is provided with the generated training data by the electronic computing device. The further trained model is provided as a personalized model for generating the at least one control signal for the at least one functional device by the electronic computing device.

Therefore, the invention provides a solution by using both, the cloud and the vehicle resources, to train models on user related data in such a way that the personalized data never leaves the motor vehicle. This approach also solves the cold start problems specific to recommended systems.

The cold start problem for artificial intelligence models refers to the situation where a new model is deployed without existing data or context information. This issue particularly affects adaptive systems that evolve based on user inputs and interactions, leading to pure performance or even malfunctions. In artificial neuronal networks (ANN) and other machine learning models the cold start problem arises where the model lacks sufficient training data resulting in an unstable and imprecise behavior. Without enough examples, the model cannot identify patterns to or relationships within the data, leading to inaccurate or even contradictory results. This problem is now solved by providing the general trained model and then further training of the general trained model inside the motor vehicle with personalized data.

According to the state of the art, federate learning is a popular part to train the models on personalized data. In the state of the art, individual models are trained on the electronic computing device, and model updates are sent to the cloud for model averaging. According to the invention, the opposite of a state of the art is provided. In a first step, training the general model in the cloud is provided and then this general trained model is used to train individual personalized models in the motor vehicle. With this approach, neither the personalized data nor the personalized model is used outside of the motor vehicle.

Therefore, the basic idea of the invention is to split the process into two stages. In the first stage, the general model is trained in the cloud using, for example, anonymized production data. In the second stage, a personalized model is trained in the vehicle using input suggestions given by the general model. With this approach, there is no need to transfer personalized data to the cloud. Furthermore, this approach provides, as already mentioned, the solution for the cold start problem.

Machine Learning (ML) is a subset of Artificial Intelligence (AI) that provides systems the ability to automatically learn and improve from experience without being explicitly programmed. It focuses on the development of computer programs that can access data and use it to learn for themselves.

Artificial Intelligence, on the other hand, is a broader concept that refers to machines or software exhibiting capabilities that mimic or simulate human intelligence. AI includes various subfields including machine learning, natural language processing, robotics, and computer vision.

Machine Learning models are trained using large datasets. Training involves optimizing the model's parameters so as to minimize a loss function that measures how well the model fits the data. The process typically involves the following steps: Data Collection: Gathering relevant data for the problem at hand is the first step in training a machine learning model. This could involve scraping websites, using APIs, or manually collecting data. Data Preprocessing: Cleaning and transforming raw data into a format suitable for training. This might include removing duplicates, handling missing values, encoding categorical variables, scaling numerical features, etc.; Model Selection: Choosing an appropriate machine learning algorithm based on the problem type (classification, regression, clustering, etc.), the nature of the data, and the desired outcome. Common model types include linear regression, logistic regression, decision trees, random forests, support vector machines, neural networks, etc.; Training: Feeding the preprocessed data into the selected model so it can learn the underlying patterns. This usually involves an optimization algorithm (like gradient descent) that iteratively adjusts the model's parameters to minimize a loss function. Evaluation: Assessing the trained model's performance on a separate validation set not used during training. Common evaluation metrics include accuracy, precision, recall, F1 score for classification tasks; mean squared error, mean absolute error, R² score for regression tasks; Hyperparameter/Fine Tuning: Adjusting settings of the model (like learning rate, regularization strength, number of layers in a neural network, etc.) to improve its performance. This is often done using techniques like grid search, random search, or Bayesian optimization. Prediction: Once satisfied with the model's performance, it can be used to make predictions on new, unseen data.

According to an embodiment, the electronic computing device generates at least one suggestion for a usage of the functional device to the user and a feedback of the user to this suggestion is received and used as the personalized data for further training the model. For example, from the general trained data a first suggestion for usage of a functional device, for example for a driving mode of the motor vehicle, is generated for the user. For example, depending on the general trained model, a driving mode for eco-driving is suggested by the model. The user can accept this suggestion or deny this suggestion. This may be used as the feedback for this suggestion. This feedback is now used in order to provide the personalized data and then the general trained model can be further trained by this decision. Furthermore, the already further trained model can also be further trained by using this feedback of the user. Therefore, an individual model for the motor vehicle can be provided in an improved manner.

According to another embodiment, the personalized model is further trained by using training data generated depending on the personal data. Therefore, the personalized model can be updated depending on the personalized data, in particular over a big timeframe. Therefore, the personalized model gets more and more individual for the user therefore a more comfortable way for using the motor vehicle is provided for the user.

In another embodiment, anonymized data is generated by the electronic computing device and transmitted to the cloud server for training the general trained model. The anonymized data may be anonymized personal data or may be general data, which do not violate the data security of private data. Therefore, this data can be used in order to train a provided model to the general trained model. It is obvious for a person skilled in the art that the anonymized data can also be provided by a plurality of other motor vehicles. Therefore, the general trained model can be trained with a high amount of anonymized data and therefore, an already well-trained general trained model can be provided for the motor vehicle.

In another embodiment, the personalized data is automatically captured by a capturing device of the motor vehicle and automatically transmitted to the electronic computing device. For example, a GPS position, an acceleration of the motor vehicle, different used tools inside the motor vehicle, fuel consumption, energy consumption or furthermore can be automatically captured by a capturing device or different capturing devices, and then transmitted to the electronic computing device as the personalized data. Depending on this data, the training data can then be generated for training the general trained model or the further trained model. Therefore, the model can be trained automatically over time.

According to another embodiment, the general trained data is stored in a storing device of the electronic computing device. Therefore, for example, for training a new received (updated) general trained model the stored training data can be used. Therefore, the stored training data may comprise a big amount of personalized data and can be used in order to individualize the new received general trained model in an improved and time—shortened manner.

According to another embodiment, the general trained data is stored for a predetermined timeframe and/or depending on a storage capacity of the storage device. For example, the general trained data can be stored for two years in the storing device. Data, which is older than two years, can be deleted from the storing device. Furthermore, if the capacity of the storage device is exceeded, the old training data can be deleted. Therefore, a big amount of training data can be provided for training the general trained model without violating the capacity of the storage device.

In another embodiment, the model is trained with a clustering algorithm and/or with the reinforcement-learning algorithm. A clustering algorithm is a type of unsupervised machine learning technique used to group similar objects or data points together based on certain characteristics, patterns, or features. The primary goal of the clustering algorithm is to discover hidden structures in unlabeled data by organizing them into mini fold clusters, where the objects with each cluster share high similarity, while those across different clusters have low similarity. Reinforcement learning is a type of machine learning that focuses on training agents to make decisions or take actions in an environment to maximize some notion of cumulative reward. The agents learn from trial and error by interacting with the environment, receiving feedback in the form of rewards or penalties, and updating its decision-making policy accordingly. The agent's goal is to find a policy, which is a mapping from states to actions that maximizes the expected cumulative reward over time. This is often expressed as the sum of discovered rewards, where future rewards are weighted less than immediate ones. The agent typically starts with initial policy and iteratively improved it through exploration, for example trying reactions, and exploitation, for example choosing actions that have proven effective in the past. It is obvious for a person skilled in the art, that also other training algorithms can be used for model training.

In particular, the method is a computer-implemented method. Therefore, another aspect of the method includes a computer program product comprising program code means for performing a method according to the preceding aspect.

Furthermore, another aspect of the method includes a non-transitory computer-readable storage medium comprising at least the computer program product according to the preceding aspect.

A still further aspect of the method includes an electronic computing device for training a model for generating at least one control signal for at least one functional device of a motor vehicle, wherein the electronic computing device is configured for performing a method according to the preceding aspect. In particular, the method is performed by the electronic computing device.

A still further aspect of the method includes a motor vehicle comprising at least the electronic computing device according to the preceding aspect.

Advantageous embodiments of the method are to be regarded as advantageous embodiments of the computer program product, the non-transitory computer-readable storage medium, the electronic computing device, as well as the motor vehicle. The electronic computing device as well as the motor vehicle therefore includes means for performing the method.

A computing unit/electronic computing device may in particular be understood as a data processing device, which includes processing circuitry. The computing unit can therefore in particular process data to perform computing operations. This may also include operations to perform indexed accesses to a data structure, for example a look-up table, LUT.

In particular, the computing unit may include one or more computers, one or more microcontrollers, and/or one or more integrated circuits, for example, one or more application-specific integrated circuits, ASIC, one or more field-programmable gate arrays, FPGA, and/or one or more systems on a chip, SoC. The computing unit may also include one or more processors, for example one or more microprocessors, one or more central processing units, CPU, one or more graphics processing units, GPU, and/or one or more signal processors, in particular one or more digital signal processors, DSP. The computing unit may also include a physical or a virtual cluster of computers or other of said units.

In various embodiments, the computing unit includes one or more hardware and/or software interfaces and/or one or more memory units.

A memory unit may be implemented as a volatile data memory, for example a dynamic random access memory, DRAM, or a static random access memory, SRAM, or as a non-volatile data memory, for example a read-only memory, ROM, a programmable read-only memory, PROM, an erasable programmable read-only memory, EPROM, an electrically erasable programmable read-only memory, EEPROM, a flash memory or flash EEPROM, a ferroelectric random access memory, FRAM, a magnetoresistive random access memory, MRAM, or a phase-change random access memory, PCRAM.

Further advantages, features, and details of the invention derive from the following description of preferred embodiment as well as from the drawing. The features and feature combinations previously mentioned in the description as well as the features and feature combinations mentioned in the following description of the figure and/or shown in the figure alone can be employed not only in the respectively indicated combination but also in any other combination or taken alone without leaving the scope of the invention.

### BRIEF DESCRIPTION OF THE DRAWING

The novel features and characteristics of the disclosure are set forth in the appended claims. The accompanying drawings, which are incorporated in and constitute a part of this disclosure, illustrate exemplary embodiments and together with the description, serve to explain the disclosed principles. The same numbers are used throughout the figures to reference like features and components. Some embodiments of system and/or methods in accordance with embodiments of the present subject matter are now described below, by way of example only, and with reference to the accompanying figures.

The drawing shows in:

FIG. 1 a schematic block diagram according to an embodiment of a motor vehicle comprising an embodiment of an electronic computing device for performing an embodiment of the method.

In the figure the same elements or elements having the same function are indicated by the same reference signs.

FIG. 2 depicts a flowchart diagram of an example method for generating at least one control signal according to example embodiments of the present disclosure.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawing and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawing that forms part hereof, and in which is shown by way of illustration a specific embodiment in which the disclosure may be practiced. This embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

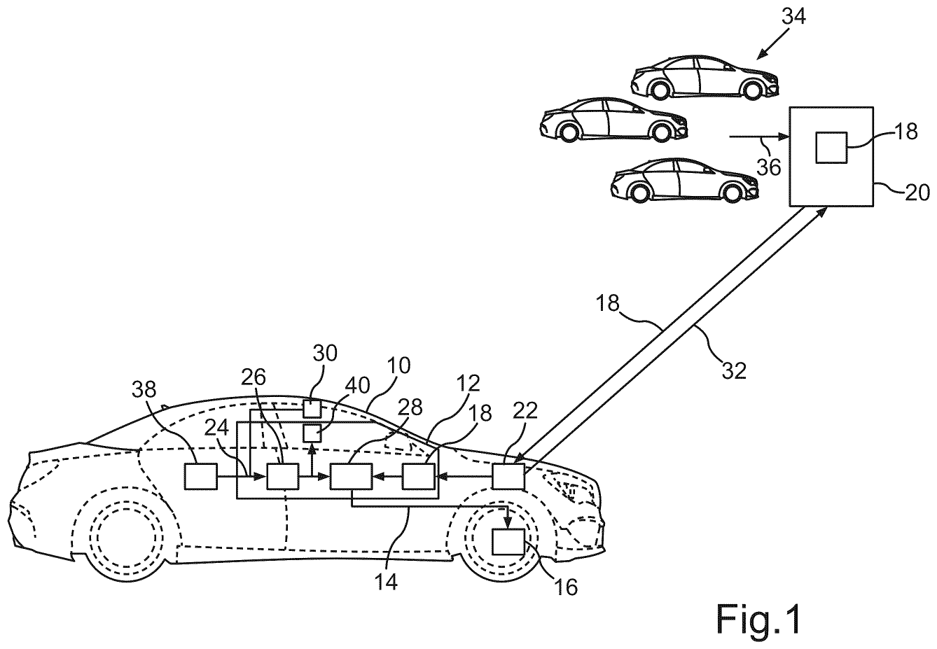

FIG. 1 shows a schematic block diagram according to an embodiment of a motor vehicle 10. The motor vehicle 10 is for example at least in part electrically operated or fully electrically operated. Furthermore, the motor vehicle 10 may be at least in part automatically operated or fully automatically operated.

The motor vehicle 10 includes at least one electronic computing device 12. The electronic computing device 12 is configured for training a model for generating at least one control signal 14 for at least one functional device 16 of the motor vehicle 10.

According to an embodiment for the method for training the model, a general trained model 18 is received from a cloud server 20 by the electronic computing device 12. As shown in FIG. 1 therefore, the motor vehicle 10 may comprise a communication device 22 for communicating with the cloud server 20. Therefore, the general trained model 18 is transmitted from the cloud server 20, for example via a network, to the communication device 22 and then provided for the electronic computing device 12. Personalized data 24 is provided from a user of the motor vehicle 10 by the electronic computing device 12. Training data 26 is generated for the general trained model 18 depending on the personalized data 24 by the electronic computing device 12. Further training of the general trained model 18 with the generated training data 26 is provided by the electronic computing device 12. The further trained model is provided as a personalized model 28 for generating the at least one control signal 14 for the at least one functional device 16.

In particular, the electronic computing device 12 may generate at least one suggestion 30 for a usage of the functional device 16 to the user and a feedback of the user to this suggestion 30 is received and used as the personalized data 24 for further training the model.

Furthermore, the personalized model 28 is further trained by using training data 26 generated depending on personalized data 24.

Furthermore, anonymized data 32 is generated by the electronic computing device 12 and transmitted to the cloud server 20 for training the general trained model 18. FIG. 1 further shows that from a plurality of motor vehicles 34 further anonymized data 36 can be provided for training the general trained model 18.

In another embodiment, the personalized data 24 is automatically captured by a capturing device 38 of the motor vehicle 10 and automatically transmitted to the electronic computing device 12.

The generated training data 26 may be stored in a storing device 40 of the electronic computing device 12. The generated trained data 26 may be stored for a predetermined time frame and/or depending on a storage capacity of the storage device 40.

Furthermore, the model is trained with a clustering algorithm and/or with a reinforcement-learning algorithm.

In particular, FIG. 1 shows that the idea of the invention is to split the process into two stages. In the first stage, the general trained model 18 is trained in the cloud server 20 using anonymized data 32, 36, which may also be regarded as a so-called production data. In the second stage, a personalized model 28 is trained in the motor vehicle 10 using as input for example suggestions 30 given by the general trained model 18. With this approach, there is no need to transfer personalized data 24 to the cloud server 20. Furthermore, this approach provides a solution for the so-called cold start problem of the model training.

The anonymized data 32, 36 is transferred from the motor vehicle 10 or from further motor vehicles 34 to the cloud server 20 and used to train a model that captures the general behavior of multiple users. Dedicated models could also be trained to target specific vehicle lines and markets, therefore improving the model performance. Since such models are trained in the cloud server 20, more complex architectures can be used. The general trained model 18 can be further trained on new incoming data, retrained or tuned depending on how the model performance changes over time. This approach also adds the flexibility to decide if the general trained model 18 runs in the cloud server 20 or in the motor vehicle 10. If the general trained model 18 is light enough it could be transferred to the motor vehicle 10 and run on-device to generate suggestions 30 for the second stage. This has the benefit of eliminating any cloud connectivity issues and minimizing their response latency. If the general trained model 18 is too complex to run in the motor vehicle 10, suggestions 30 can be generated in the cloud server 20 and sent to the motor vehicle 10. This approach introduces a larger latency and a potential connectivity problem with the backend. In either case, these problems are minimized by running the second stage in the motor vehicle 10. This approach also simplifies the handling of data, model, and suggestion transfer between the cloud server 20 and the motor vehicle 10 since no encryption is necessary.

Once suggestions 30 are generated, either in the cloud server 20 or in the motor vehicle 10, this is used as an input for the model training in the electronic computing device 12. The personalized data 24 is used in the motor vehicle 10 to train such models, which may usually include automatic user feedback regarding the generated suggestions 30, and any relevant in-vehicle user actions and specific context data. For the current use case, the in-vehicle model is used to automate specific vehicle functions, in particular routines, but any other personalization model can be trained and used in the second stage. The best models that may work in this case are the ones that can be easily trained in an incremental manner, otherwise a more convoluted approach is needed. These personalized models 28 could be also transferred to the cloud server 20, in encrypted form, as a backup solution and to be able to transfer them to new vehicles for the same user.

Furthermore, as already mentioned, the personalization stage is provided inside of the motor vehicle 10, so no data transfer/anonymization/encryption is required. Nevertheless, since this may only happen in the motor vehicle 10, the training data 26 is needed to be kept inside the motor vehicle 10 for some time. This is for example needed, if the models need to be re-trained from scratch, as an example, when a new algorithm is introduced.

Furthermore, several models could be used, depending on the specific use case. For example, as already mentioned, the clustering algorithm or the reinforcement-learning algorithm may be used.

One main advantage of this idea is that the user data remains inside the motor vehicle 10. This approach provides a better user privacy and security. It also simplifies the architecture of the entire system. No data transfer, anonymization, or encryption is needed. It also reduces the overall costs for the company given that the personalized models 28 are trained inside the motor vehicle 10. Another advantage relates to the availability. An onboard model may always be available to the user irrespective of the network/cloud connectivity.

As an example for the drive modus use case the general trained model 18 is trained on production data in the cloud server 20 to suggest a change in the drive mode, for example between eco-mode, comfort mode, or sport mode, based on multiple vehicle signals. For a particular user the model may provide a suggestion 30, for example to change from comfort mode to sport mode. If the user accepts this suggestion 30, this may be used as positive feedback and is used as an input for the second stage personalization model. If the user ignores or cancels the suggestion 30, this may be used as a negative feedback to the personalized model 28. Suggestion 30 for changing the drive mode may happen from time to time, for example every 10 to 20 minutes. Every time a suggestion 30 is presented to the user, the corresponding feedback, either positive or negative, is used to increment and train the personalized model 28 in the motor vehicle 10. Similarly, if the user changes the drive mode manually, without relying on the suggestion 30, this may be considered as a so-called user action and also may be used as an input to further train the personalized model 28. Besides these, direct or indirect user feedback, the full set for a limited set of the input features that are used to train the general trained model 18 in the cloud server 20 is used as an input to train the personalized model 28 in the motor vehicle 10.

In particular, the driving dynamics of the motor vehicle 10 are tightly coupled to the chosen drive mode. Most motor vehicles 10 have multiple drive modes available to the driver to choose from. Each drive mode is focused on a specific driving style or road condition. For example, ECO mode is focused more on fuel efficiency, while SPORT mode is focused more on vehicle performance. Choosing one drive mode over another is a task that currently is done manually by the driver based on his or her driving style or perceived driving conditions. Even though most motor vehicles 10 have several drive modes to choose from, most drivers barely change them or don't change them at all, therefore not using the full potential of the vehicle they drive.

One embodiment relies on ML (machine learning) algorithms to suggest changes to the active drive mode based on various signals and user preferences and ultimately automates the process. To accomplish this, the general trained model 18 is first trained on data recorded from production vehicles that capture the common behavior of drivers across different vehicle lines and market segments. Historical anonymized data with no connection to the driver is used to train the general trained model 18. The training data 26 includes signals describing the vehicle dynamics, vehicle model, road conditions and outside environment. To improve the model performance, a mix of drive mode transition and non-transition events are used during the training stage. The stability of the model during the inference stage is further improved by adding a Markov Chain process that filters out potential noise in the suggested drive mode. The general trained model 18 can either run in the cloud and provide drive mode suggestions for all drivers, or it can be deployed to the motor vehicle 10 and run locally without any connection to the backend.

The personalization stage is done only in the motor vehicle 10 by training personalized model 26 on driver actions to the suggested drive modes. If a driver accepts the suggested drive mode the event is considered a positive action, otherwise it is considered as a negative action. In time the personalized model 26 captures more and more of the driver's specific style and preferences. Once a certain level of confidence is attained for the personalized model 28, automation of the drive mode change can be introduced.

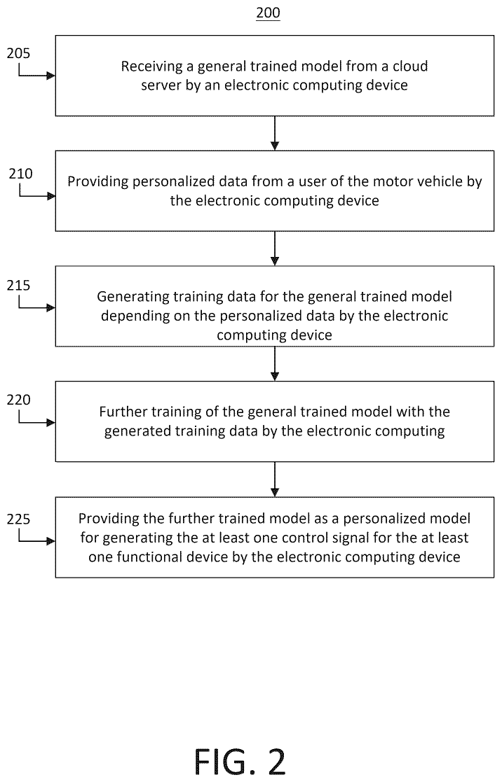

FIG. 2 depicts a flowchart diagram of an example method 200 for generating at least one control signal according to example embodiments of the present disclosure. The method can be performed by an electronic device or computing system that includes one or more computing devices such as, for example, the electronic computing devices or computing systems described with reference to the other figure. Each respective portion of the method 200 can be performed by any (or any combination) of one or more computing devices. Moreover, one or more portion of the method 200 can be implemented on an electronic computing device of the motor vehicle described herein.

FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for example illustrated purposes and is not meant to be limiting. One or more portions of method 200 can be performed additionally, or alternatively, by other systems.

In an embodiment, the method 200 may include operation 205, which includes receiving a general trained model from a cloud server by an electronic computing device. The general trained model can generate training data depending on the personalized data by the electronic computing device. In some implementations, the general trained model can be trained on data recorded from production vehicles that capture the common behavior of drivers across different vehicle lines and market segments. For example, historical anonymized data with no connection to the driver is used to train the general trained model.

In an embodiment, the method 200 can include operation 210, which includes providing personalized data from a user of the motor vehicle by the electronic computing device. In some implementations, the electronic computing device generates at least one suggestion for a usage of the functional device to the user and a feedback of the user to this suggestion is received and used as the personalized data for further training the model. In some implementations, the personalized data can be automatically captured by a capturing device of the motor vehicle and automatically transmitted to the electronic computing device.

In an embodiment, the method 200 can include operation 215, which includes generating training data for the general trained model depending on the personalized data by the electronic computing device. For example, the training data can include signals describing the vehicle dynamics, vehicle model, road conditions and outside environment. In some implementations, anonymized data is generated by the electronic computing device and transmitted to the cloud server for training the general trained model. In some implementations, the generated training data is stored in a storing device of the electronic computing device. In some implementations, the general trained model can be run in the cloud server or in the motor vehicle. In some implementations, the general trained model is trained with a clustering algorithm and/or with a reinforcement-learning algorithm. In some implementations, the general trained model suggests a driving mode for the user to accept or reject. For example, if a driver accepts the suggested drive mode, the event is considered a positive action, otherwise it is considered a negative action. This allows the personalized model to capture more and more of the driver's specific style and preferences.

In an embodiment, the method 200 can include operation 220, which includes further training the general trained model with the generated training data by the electronic computing. For example, the general trained model can be further trained on new incoming data, retrained, or tuned depending on how the model performance changes over time. In some implementations, the generated training data is stored for a predetermined time frame and/or depending on a storage capacity of the storage device.

In an embodiment, the method 200 can include an operation 225, which includes providing the further trained model as a personalized model for generating the at least one functional device by the electronic computing device. In some implementations, the personalized model is further trained by using training data generated depending on personalized data. In some implementations, an electronic computing device generates at least one control signal for at least one functional device of a motor vehicle.

The method will help drivers start exploring different drive modes and therefore make use of a technology that is currently heavily unutilized in vehicles, which could lead to a better driving experience. This could also improve fuel efficiency if the ECO mode is used more often.

1. A method for training a model for generating at least one control signal for at least one functional device of a motor vehicle by an electronic computing device of the motor vehicle, comprising:
receiving a general trained model from a cloud server by the electronic computing device;
providing personalized data from a user of the motor vehicle by the electronic computing device;
generating training data for the general trained model depending on the personalized data by the electronic computing device;
further training of the general trained model with the generated training data by the electronic computing; and
providing the further trained model as a personalized model for generating the at least one control signal for the at least one functional device by the electronic computing device.

2. The method of claim 1, wherein
the electronic computing device generates at least one suggestion for a usage of the functional device to the user and a feedback of the user to this suggestion is received and used as the personalized data for further training the model.

3. The method according to claim 1, wherein
the personalized model is further trained by using training data generated depending on personalized data.

4. The method according to claim 1, wherein
anonymized data is generated by the electronic computing device and transmitted to the cloud server for training the general trained model.

5. The method according claim 1, wherein
the personalized data is automatically captured by a capturing device of the motor vehicle and automatically transmitted to the electronic computing device.

6. The method according to claim 1, wherein
the generated training data is stored in a storing device of the electronic computing device.

7. The method according to claim 6, wherein
the generated training data is stored for a predetermined time frame and/or depending on a storage capacity of the storage device.

8. The method according to claim 1, wherein
the general trained model is trained with a clustering algorithm and/or with a reinforcement-learning algorithm.

9. The method according to claim 1, wherein the general trained model suggests a driving mode for the user to accept or reject.

10. An electronic computing device for training a model for generating at least one control signal for at least one functional device of a motor vehicle, wherein the electronic computing device is configured for performing a method according to claim 1.

11. A computing system comprising:
one or more processors; and
one or more non-transitory computer readable media storing instructions that are executable by the one or more processors to perform operations, the operations comprising:
receiving a general trained model from a cloud server by an electronic computing device;
providing personalized data from a user of the motor vehicle by the electronic computing device;
generating training data for the general trained model depending on the personalized data by the electronic computing device;
further training of the general trained model with the generated training data by the electronic computing; and
providing the further trained model as a personalized model for generating the at least one control signal for the at least one functional device by the electronic computing device.

12. The computing system of claim 11, wherein the electronic computing device generates at least one suggestion for a usage of the functional device to the user and a feedback of the user to this suggestion is received and used as the personalized data for further training the model.

13. The system according to claim 11, wherein the personalized model is further trained by using training data generated depending on personalized data.

14. The system according to claim 11, wherein anonymized data is generated by the electronic computing device and transmitted to the cloud server for training the general trained model.

15. The system according to claim 11, wherein the personalized data is automatically captured by a capturing device of the motor vehicle and automatically transmitted to the electronic computing device.

16. The system according to claim 11, wherein the generated training data is stored in a storing device of the electronic computing device.

17. The system according to claim 11, wherein the generated training data is stored for a predetermined time frame and/or depending on a storage capacity of the storage device.

18. The system according to claim 11, wherein the general trained model is trained with a clustering algorithm and/or with a reinforcement-learning algorithm.

19. The system according to claim 11, wherein the general trained model suggests a driving mode for the user to accept or reject.

20. One or more non-transitory computer readable media storing instructions that are executable by one or more processors to perform operations, the operations comprising:
receiving a general trained model from a cloud server by an electronic computing device;
providing personalized data from a user of the motor vehicle by the electronic computing device;
generating training data for the general trained model depending on the personalized data by the electronic computing device;
further training of the general trained model with the generated training data by the electronic computing; and
providing the further trained model as a personalized model for generating the at least one control signal for the at least one functional device by the electronic computing device.
